(19) United States
(12) Patent Application Publication
(10) Pub. No.: US 2007/0147700 A1
(43) Pub. Date: Jun. 28, 2007

(54) Method and apparatus for editing images using contour-extracting algorithm

(75) Inventors: Jin Guk Jeong, Suwon-si (KR); Young Su Moon, Seoul (KR); Ji Yeun Kim, Seoul (KR); Maolin Chen, Beijing (CN); Ma Gangyu, Beijing (CN)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/491,968

(22) Filed: Jul. 25, 2006

(30) Foreign Application Priority Data
Dec. 28, 2005 (KR) 10-2005-0131986

(51) Int. Cl. G06K 9/40; G06K 9/48

(52) U.S. Cl. 382/266; 382/199

(57) ABSTRACT

Disclosed herein is a method and apparatus for editing an image using an object contour extracted from an input image. The method of editing an image using a contour-extracting algorithm includes: inputting image data; extracting an object contour from the input image data; optimizing the extracted contour using the characteristics of the input image data; editing the input image data using the optimized contour; and outputting the edited image data.

### CROSS-REFERENCE TO RELATED APPLICATIONS

This application claims the benefit of Korean Patent Application No. 10-2005-0131986, filed on Dec. 28, 2005, in the Korean Intellectual Property Office, the disclosure of which is incorporated herein by reference.

### BACKGROUND OF THE INVENTION

1. Field of the Invention

The present invention relates to a method and apparatus for editing an image using a contour-extracting algorithm, and more particularly to a method and apparatus for editing an image using a contour extracted from an input image.

2. Description of the Related Art

A conventional object contour-extracting method using an energy-based algorithm is described in U.S. Pat. No. 6,912,310 in which an object is extracted from a first image frame and then object template matching is performed for a subsequent image frame. However, such an object contour-extracting method has a problem in that in the case of application to a video with a complex background, an edge portion of an object contour as well as a background within the video is increased in density, which makes it difficult to substantially and precisely identify the object contour.

Also, a conventional object contour-extracting method based on color and motion region segmentation is described in U.S. Pat. No. 6,785,329 in which a video is segmented in a Blob format using color information and the object contour is extracted through the segmentation and combination of Blobs. However, such an object contour-extracting method encounters a problem in that in the case of application to a video with a complex background, the video is segmented into a huge number of Blobs, which makes it difficult to substantially and precisely identify the contour of the object.

Also, in the case of a conventional contour model-based object contour-extracting method, the contour model is formed using a training sample and contour searching is performed to maintain the form of the contour model. But such a contour model-based object contour-extracting method also has a shortcoming in that it depends on learning a data characteristic since control points are detected based only on the contour model, such that if there is a slight difference between learned contour models, it is difficult to identify an appropriate object contour.

As such, the conventional object contour-extracting methods make it difficult to substantially and precisely identify an object contour.

Therefore, there is an urgent need for a solution that substantially and precisely detects a contour of an object and edits an image using the detected contour.

### SUMMARY OF THE INVENTION

Accordingly, the present invention has been made in view of the aforementioned problems occurring in the prior art, and it is an aspect of the present invention to provide a method and apparatus for editing an image using an object contour to extract, from a complex background image, a body in a foreground.

Another aspect of the present invention is to provide an image-editing method and apparatus, in which an object contour extracted from an image data is optimized to be synthesized with any other background scene.

Still another aspect of the present invention is to provide an image-editing method and apparatus, in which an object contour extracted from an image data is optimized, a clothing region and a facial region of the image object, i.e. a person, is segmented using skin color detection, and the shape of the segmented clothing region and the brightness of the segmented facial region are adjusted.

Yet another aspect of the present invention is to provide an image-editing method and apparatus, in which an object contour extracted from image data is optimized, and the brightness of the background region is then adjusted.

According to one aspect of the present invention, there is provided a method of editing an image using an object contour-extracting algorithm, the method including: inputting image data; extracting an object contour from the input image data; optimizing the extracted contour using the characteristics of the input image data; editing the input image data using the optimized extracted contour; and outputting the edited image data.

According to another aspect of the present invention, there is also provided an apparatus for editing an image using an object contour-extracting algorithm, the apparatus including: an image input section for inputting image data; an object contour-extracting section for extracting an object contour from the input image data applied to the object contour-extracting section from the image input section; an object contour-optimizing section for optimizing the extracted contour applied to the object contour-optimizing section from the object contour-extracting section using the characteristics of the input image data; an image-editing section for editing the image data using the optimized extracted object contour applied to the image-editing section from the object contour-optimizing section; and an image output section for outputting the edited image data applied thereto from the image-editing section.

Additional aspects and/or advantages of the invention will be set forth in part in the description which follows and, in part, will be apparent from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram illustrating the inner construction of an apparatus for editing an image using an object contour-extracting algorithm according to one embodiment of the present invention;

FIG. 2 is a flowchart illustrating the process of editing an image using an object contour-extracting algorithm according to one embodiment of the present invention;

FIG. 3 is a flowchart illustrating the process of extracting an initial object contour in the image-editing method according to an embodiment of the present invention;

FIG. 4 is an example of image data used in the process of initially extracting an object contour in the image-editing method according to an embodiment of the present invention;

FIG. 5 is a flowchart illustrating the process of optimizing the extracted object contour in the image-editing method according to an embodiment of the present invention;

FIG. 6 is an example of detection of control points in the image-editing method according to an embodiment of the present invention;

FIG. 7 is a diagram illustrating an example for updating a contour model in the image-editing method according to an embodiment of the present invention;

FIG. 8 is a flowchart illustrating a user correction process in the image-editing method according to an embodiment of the present invention;

FIG. 9 is a flowchart illustrating a process for editing the image data using the optimized object contour in the image-editing method according to an embodiment of the present invention;

FIG. 10 is a pictorial diagram illustrating an example of an image editing process for inserting an image object, i.e. a person, into a background image in the image-editing method according to an embodiment of the present invention;

FIG. 11 is a flowchart illustrating a process for inserting an image object, i.e. a person, into the background image of FIG. 9 in the image-editing method according to an embodiment of the present invention; and

FIG. 12 is a flowchart illustrating a process for editing images for clothing and facial regions of a person in the image-editing method according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to like elements throughout. The embodiments are described below in order to explain the present invention by referring to the figures.

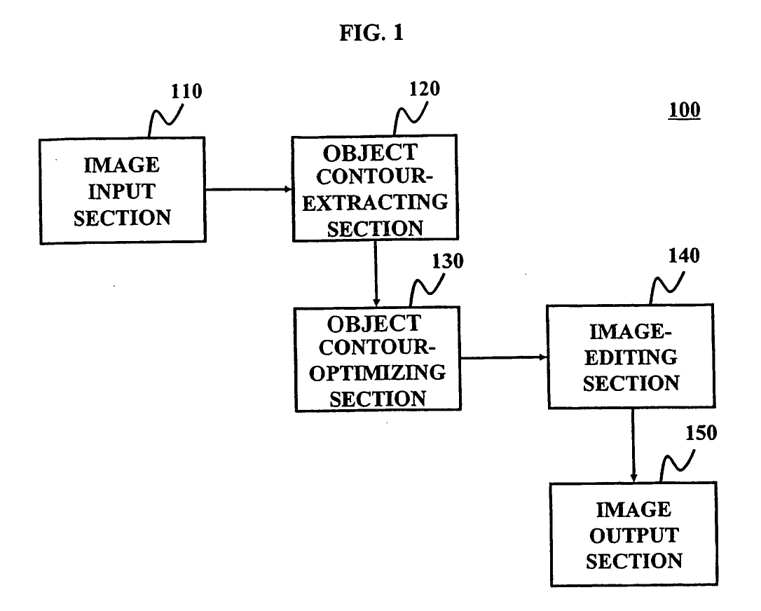

FIG. 1 is a block diagram illustrating the inner construction of an apparatus for editing an image using an object contour-extracting algorithm according to one embodiment of the present invention.

Referring to FIG. 1, an image-editing apparatus 100 is shown that includes an image input section 110, an object contour-extracting section 120, an object contour-optimizing section 130, an image-editing section 140, and an image output section 150.

The image input section 110 is inputted with image data including data of a person that is to be edited.

The object contour-extracting section 120 extracts an object contour from the input image data applied thereto from the image input section 110. That is, the contour-extracting section 120 can detect at least one of a face, eyes, and a skin color of an image object, i.e. a person, from the input image data, or extract a position of the person through an entry of a user and extract an initial object contour from the data of the person, which is contained in the image data using a specific contour model.

The object contour-optimizing section 130 optimizes the extracted object contour applied thereto from the object contour-extracting section 120 using the characteristics of the input image data. That is, the object contour-optimizing section 130 can optimize the extracted initial contour using characteristics of energy or an edge of the input image data.

The image-editing section 140 edits the input image data using the optimized contour applied thereto from the contour-optimizing section 130.

The image-editing section 140 can edit the image data using the optimized contour to segment a clothing region and a facial region of an image object, i.e. a person, using skin color detection, and adjust the shape of the segmented clothing region and the brightness of the segmented facial region. The image-editing section 140 can also edit the image data to adjust the brightness of a background region for the image data.

The image output section 150 outputs the edited image data applied thereto from the image-editing section 140.

As such, the image-editing apparatus according to the present invention extracts an object contour from the input image data, such as a contour of a person, and optimizes the extracted contour to more precisely detect the contour of the object, for example, the person.

Accordingly, the image-editing apparatus according to the present invention can edit the image in various fashions such as synthesizing an image object, i.e. a person, with any other background image, deforming the clothing shape or the face of the person, adjusting the brightness of the background screen, etc., using the precisely detected object contour.

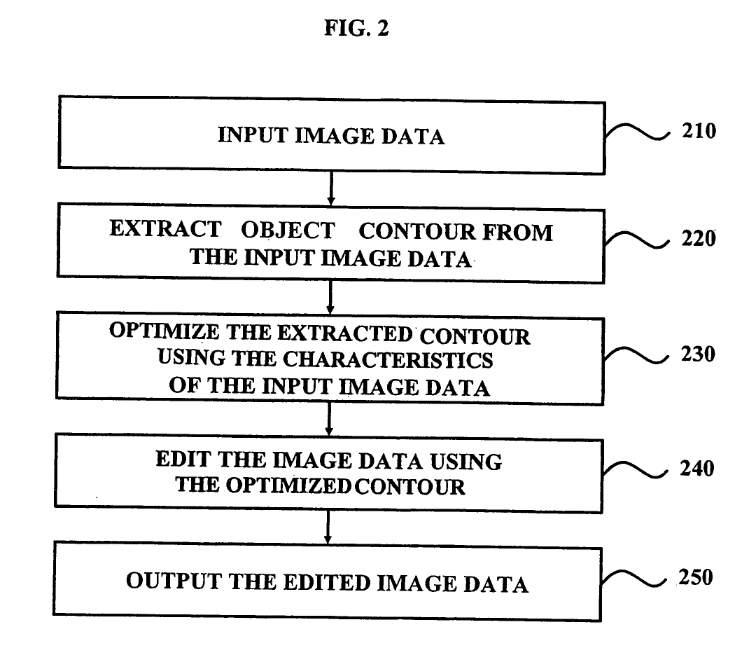

FIG. 2 is a flowchart illustrating a process of editing an image using a contour-extracting algorithm according to one embodiment of the present invention.

Referring to FIG. 2, in operation 210, the image-editing apparatus according to the present invention is input with image data including data of a person that is to be edited.

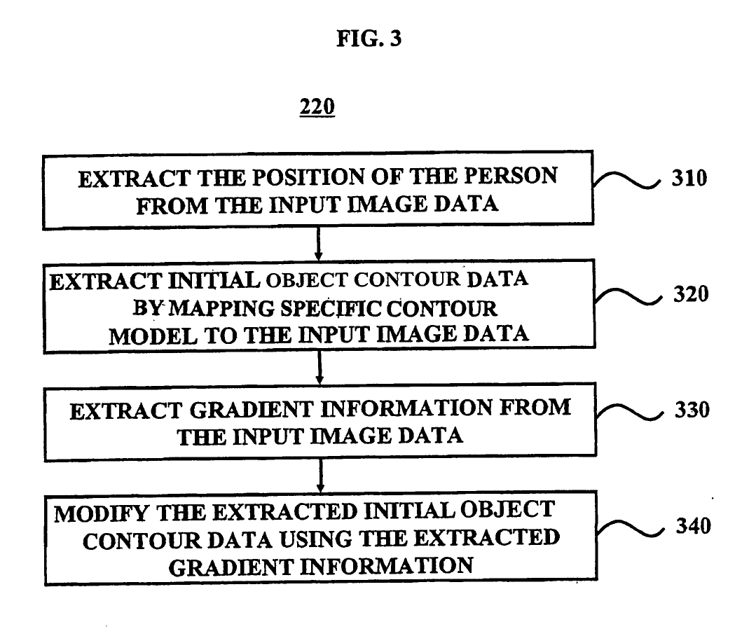

In operation 220, the image-editing apparatus 100 extracts an object contour from the input image data. The process for extracting an initial contour in operation 220 will be described hereinafter in more detail with reference to FIG. 3.

FIG. 3 is a flowchart illustrating the process for extracting an initial object contour in the image-editing method according to an embodiment of the present invention.

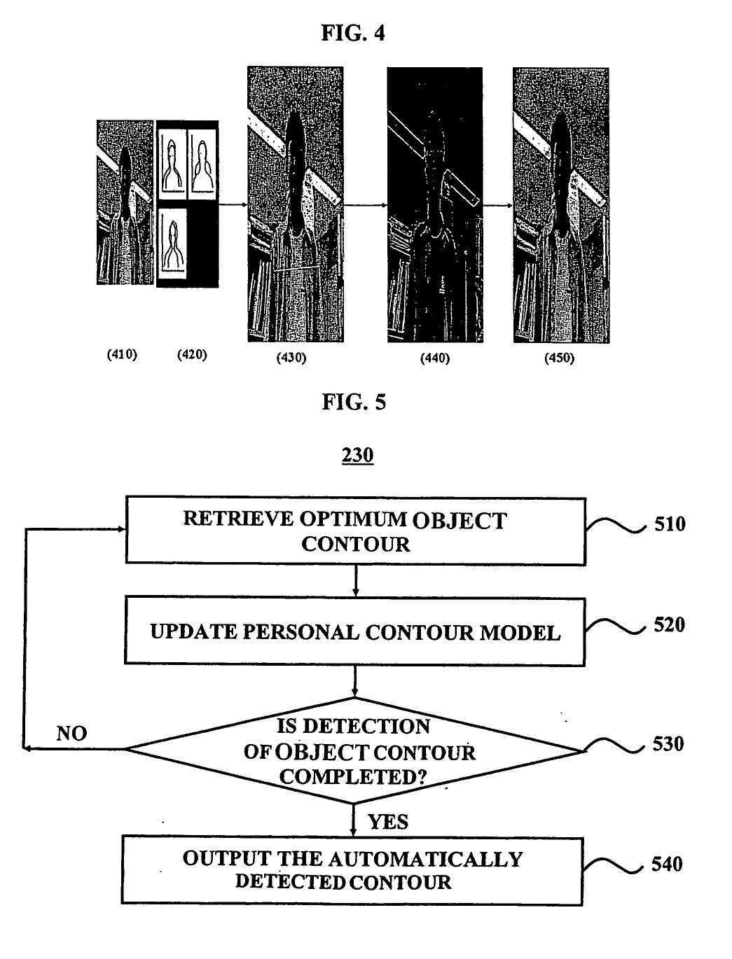

Referring to FIG. 3, in operation 310, the image-editing apparatus 100 extracts a position of an image object, i.e. a person, from input image data 410 as shown in FIG. 4. For example, in operation 310, the image-editing apparatus 100 detects at least one of a face, eyes, and a skin color of the person from the input image data, or extracts the position of the person through entry by a user.

In operation 320, the image-editing apparatus 100 extracts initial contour data 430 from the input image data 410 using a specific object contour model 420 as shown in FIG. 4.

In operation 320, the image-editing apparatus 100 can extract the size of the person based on, for example, the distance between both eyes of the detected person, and then map the specific contour model 420 to the input image data 410 to extract the initial object contour data 430.

The initial contour data 430 allows the contour for the input image data 410 to be represented as control points for main pixels.

In operation 320, the image-editing apparatus 100 extracts the size of the person based on, in this example, the distance between both eyes of the person, and subjects the extracted size of the person to a model scaling to represent the object contour as control points.

In operation 320, the image-editing apparatus 100 can represent the contour model by eigenvectors generated using training images labeled manually by a principle component analysis (PCA).

In operation 330, the image-editing apparatus 100 extracts gradient information included in a gradient vector flow (GVF) image data 440 shown in FIG. 4 from the input image data.

Also, in operation 330, the image-editing apparatus 100 can extract the gradient information from the input image data 410 using a gradient vector flow (GVF). A gradient direction of the image in the GVF denotes a direction in which an edge density of a pixel is high. That is, according to the GVF image data 440 as shown in FIG. 4, a zero crossing in which the direction of the gradient vector alters occurs in the pixel whose edge density is high.

Subsequently, in operation 340, the image-editing apparatus 100 modifies the extracted initial contour data to conform to the extracted gradient information from the input image data.

In operation 340, the image-editing apparatus 100 can move the control points of the initial contour to a neighboring pixel whose edge density is high.

Namely, in operation 340, the image-editing apparatus 100 can provide the modified object contour image data 450 as shown in FIG. 4 by moving the control points of the initial object contour to a point where the direction of the gradient vector alters.

As such, the image-editing method according to an embodiment of the present invention can extract the initial object contour in a form as close as possible to the form of the person so as to increase precision and efficiency in detection of the contour.

In operation 230, the image-editing apparatus 100 optimizes the extracted object contour using characteristics of the input image data. The process for optimizing the extracted contour in operation 230 will be described hereinafter in more detail with reference to FIG. 5.

FIG. 5 is a flowchart illustrating the process of optimizing the extracted object contour in the image-editing method according to an embodiment of the present invention.

Referring to FIG. 5, in operation 510, the image-editing apparatus 100 retrieves the optimum object contour using the characteristics of the input image data and a specific learned contour model.

That is, in operation 510, the image-editing apparatus 100 can retrieve control points of the optimum object contour from current image data using the characteristics of the input image data and the contour model.

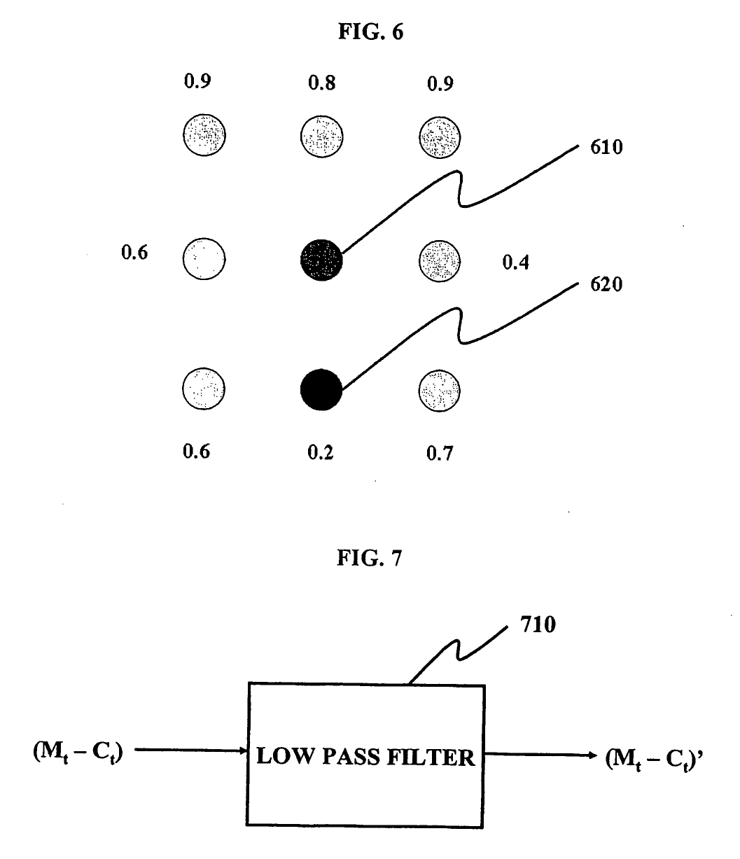

In operation 510, as shown in FIG. 6, the image-editing apparatus 100 can select a neighboring pixel in which a result value of an energy function (E) for a current control point 610 is a minimum, and determine the selected neighboring pixel as a next control point 620 which is a new control point. The energy function (E) is an objective function that specifies the condition for deciding the next control point corresponding to the object contour. The energy function (E) consists of E_{continuity}, Eₛₘₒₒₜₕₙₑₛₛ, E_{Edge}, E_{Shape}, and E_{Color}, as given by Equation 1 below:
E=α=E_{continuity}+β×Eₛₘₒₒₜₕₙₑₛₛ+γ×E_{Edge}κ×E_{Shape}+λ×E_{Color} [Equation 1]
where α, β, γ, κ and λ denote the weighted values for respective terms of the energy function (E).

E_{continuity} denotes a function representing whether or not a curve represented by the control point has continuity and can be represented as a first derivative value. The E_{continuity} can be expressed as given by Equation 2.
E_{continuity}=∥pᵢ−pᵢ₋₁∥² [Equation 2]
where pᵢ denotes information about the i^{th} pixel. Eₛₘₒₒₜₕₙₑₛₛ denotes a function representing whether or not a curve represented by the control point is smoothly connected in a curvature form, has continuity and can be represented as a second derivative value. The Eₛₘₒₒₜₕₙₑₛₛ can be expressed as given by Equation 3.
Eₛₘₒₒₜₕₙₑₛₛ∥pᵢ₋₁−2×pᵢ+pᵢ₊₁∥² [Equation 3]

E_{Edge} is a function representing whether or not a curve represented by the control point is similar to an edge of the input image data. E_{Edge} is a distance between the control point and a zero crossing point on the GVF image data and can be used as an edge density.

E_{Shape} is a function representing whether or not a shape represented by the control point is similar to that of the object contour model. E_{Shape} is a comparison value between the control point and the contour model and can be expressed as given by Equation 4.
E_{Shape}=∥Cᵢ−Mᵢ∥²,
Cᵢ=Control Points, Mᵢ=Model Control Points [Equation 4]

E_{Color} is a function representing whether or not there is a difference in color in the surroundings of the control point and can be expressed as a reciprocal of a dispersion value of a color difference between the control point and the surrounding pixels. In this case, as the dispersion value of the color difference increases, the probability that the control point is within the boundary of the image object, i.e. the person, increases.

In operation 520, the image-editing apparatus 100 updates the contour model using the retrieved optimum object contour. In other words, in operation 520, the image-editing apparatus 100 can modify the contour model by the sample to conform to the current object contour.

In operation 520, the image-editing apparatus 100 can assume a currently detected control point as an optimum control point and use the currently-detected control point to update the contour model.

Also in operation 520, the image-editing apparatus 100 can add a difference value between the currently-detected control point and the control point of the contour model to the control point of the contour model.

In operation 520, as shown in FIG. 7, the image-editing apparatus 100 allows a difference value (Mₜ−Cₜ) between the control point (Mₜ) of the contour model and the currently-detected control point (Cₜ) to pass through a low-pass filter 710, and then adds a value (Mₜ−Cₜ)′, in which a noise is eliminated, to the control point (Mₜ) of the contour model so that the control point (Mₜ₊₁) of the updated contour model can be calculated as given by Equation 5.
Mₜ₊₁=Mₜ+(Mₜ−Cₜ)′[Equation 5]

In operation 530, the image-editing apparatus 100 determines whether or not the detection of the contour from the input image data is completed. That is, in operation 530, the image-editing apparatus 100 can restrict the detection completion test for the object contour to, for example, a number of times of detection, whether or not there is a convergence of the retrieval function of an optimum object contour, etc.

If it is determined in operation 530 that the detection of the contour has not been completed, the program returns to operation 510, and in this manner the image-editing apparatus 100 repeatedly performs the operation 510 until the detection of the object contour is completed.

On the other hand, if it is determined in operation 530 that the detection of the contour has been completed, the process proceeds to operation 540, where the image-editing apparatus 100 outputs a result of the automatically-detected contour.

As such, the image-editing method according to the present invention precisely extracts the contour of an object image region to be synthesized so that the editing work using the extracted contour can be more naturally performed.

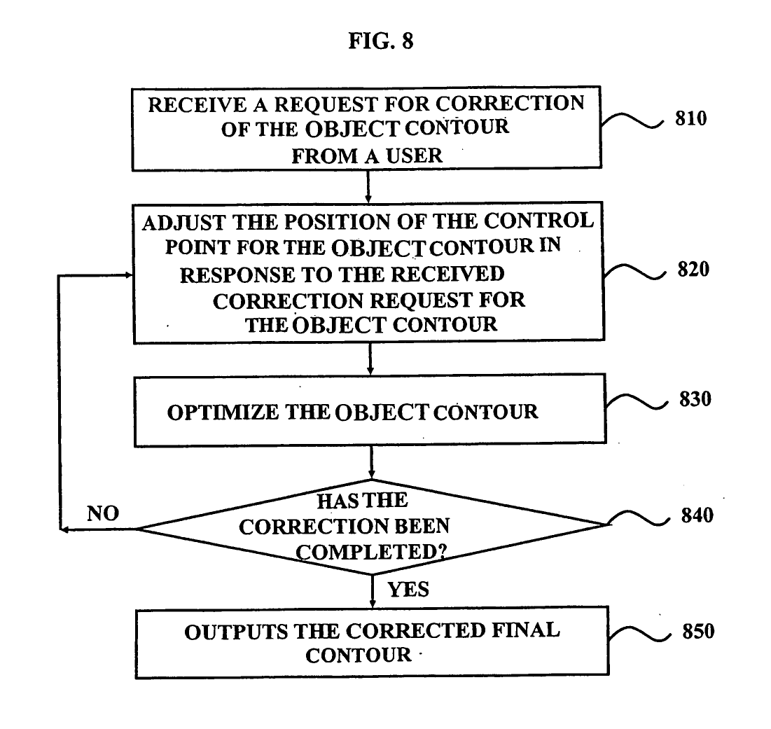

FIG. 8 is a flowchart illustrating a user correction process in the image-editing method according to an embodiment of the present invention.

Referring to FIG. 8, in operation 810, the image-editing apparatus 100 receives a request for correction of the contour from a user to adjust the position of the control point for the automatically-detected contour. At this time, the user evaluates a result of the automatically-detected contour. If it is determined that the result of the automatically-detected contour is not satisfactory, the user can adjust the result of the automatically-detected contour through the request for correction of the contour.

In operation 820, the image-editing apparatus 100 adjusts the position of the control point for the automatically-detected contour in response to the received request for correction of the contour.

In operation 830, the image-editing apparatus 100 optimizes the object contour according to the energy function which has been altered due to the adjusted control point position.

In operation 840, the image-editing apparatus 100 determines whether or not the correction of the contour has been completed.

If it is determined in operation 840 that the correction of the contour has not been completed, the program returns to the previous operation 820, and in this manner the image-editing apparatus 100 repeatedly performs the operation 820 until the correction of the contour is completed.

If, on the other hand, it is determined in operation 840 that the correction of the contour has been completed, the program proceeds to operation 850, where the image-editing apparatus 100 outputs the final object contour in which the correction of the contour has been completed to provide the output contour to the user.

As such, the image-editing method according to the present invention allows the user to adjust the result of the automatically-detected contour to provide a satisfactory contour result to the user.

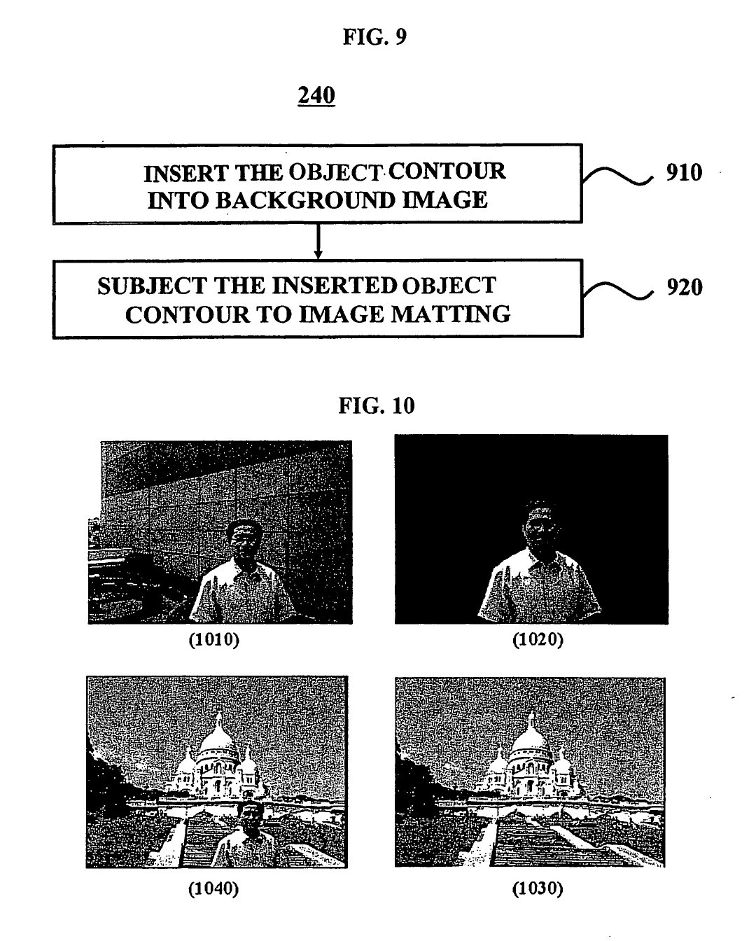

Referring back to FIG. 2, in operation 240, the image-editing apparatus 100 edits the image data using the optimized object contour. The process for the image-editing apparatus 100 to edit the image data to insert the optimized personal contour into a background image in operation 240 will be described hereinafter in more detail with reference to FIG. 9.

FIG. 9 is a flowchart illustrating a process for editing the image data using the optimized contour in the image-editing method according to an embodiment of the present invention.

Referring to FIG. 9, in operation 910, the image-editing apparatus 100 inserts the optimized contour into a predetermined background image. That is, in operation 910, the image-editing apparatus 100 scales the optimized contour to conform to the background image at a position designated by a user or automatically designated by a system, and then inserts the scaled contour into the background image. As an example of editing image data, a position where an edge density of the background image is lowest may be designated as a position for the image object, i.e. the person, to be inserted in the system.

FIG. 10 is a pictorial diagram illustrating an example of an imageediting process for inserting an image object, i.e. a person, into a background image in the image-editing method according to an embodiment of the present invention.

Referring to FIG. 10, first image data 1010 is image data including data of a person to be edited, second image data 1020 is data of a person obtained by extracting an objectregion, i.e., a region including the image of the person, from the first image data 1010. Third image data 1030 is image data including background data to be edited, and fourth image data 1040 is image data obtained by synthesizing the second image data 1020 as the extracted data of an object, i.e., a person, with the third image data 1030 as the background data.

As such, the image-editing method according to the present invention may extract a contour from the input image data, and insert the extracted contour into background data, which a user wants to synthesize, in a suitable size.

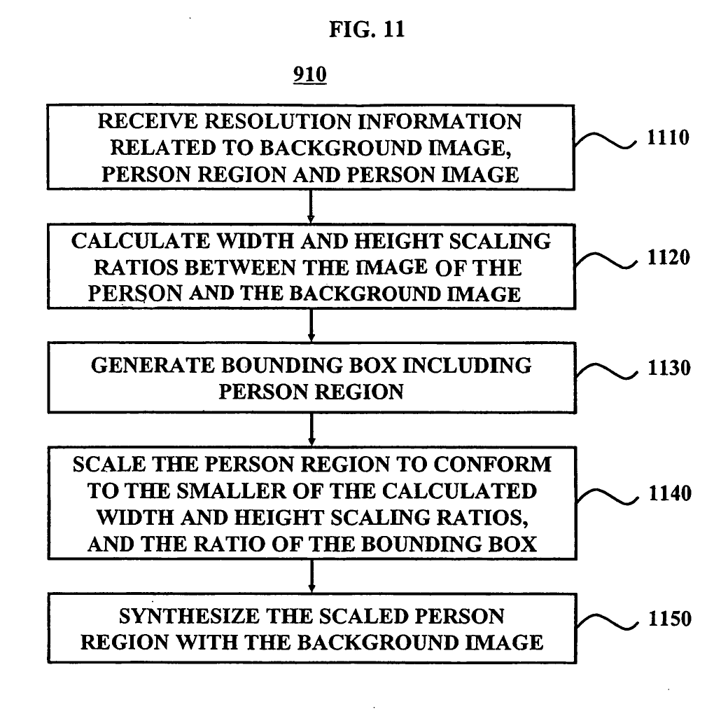

The process for the image-editing apparatus 100 to insert the image object, i.e. the person, into a background image in operation 910 will be described hereinafter in more detail with reference to FIG. 11.

FIG. 11 is a flowchart illustrating a process for inserting an image object, i.e. a person, into the background image of FIG. 9 in the image-editing method according to an embodiment of the present invention.

Referring to FIG. 11, in operation 1110, the image-editing apparatus 100 receives resolution information related to a background image, an object region including an image of a person, and the image of the person.

In operation 1120, the image-editing apparatus 100 calculates a scaling ratio between the image of the person and the background image. For example, in the case where a resolution of the image of the person is 320*240 and a resolution of the background image is 240*240, the width scaling ratio (Wᵣ) between the image of the person and the background image is 0.75(240/320), and the height scaling ratio (Hᵣ) between the image of the person and the background image is 1(240/240).

In operation 1130, the image-editing apparatus 100 generates a bounding box using the largest width and height in the object region. For example, in the case where the largest width is ‘40’ and the largest height is ‘80’ in the object region, the size of the bounding box is ‘40*80’.

In operation 1140, the image-editing apparatus 100 scales the object region to conform to the smaller one of the calculated width and height scaling ratios between the image of the person and the background image, and the ratio of the bounding box.

The case where the width scaling ratio (Wᵣ) is ‘0.75’, the height scaling ratio (Hᵣ) is ‘1’, and the size of the bounding box is ‘40*80’ will be described hereinafter as an example.

In operation 1140, the image-editing apparatus 100 performs a sub-sampling for the width of the bounding box so that the size of the width scaling ratio and the width of the bounding box becomes ‘40*0.75=30’, and performs the sub-sampling for the height of the bounding box so that the ratio of the width and the height of the bounding box maintains a relationship of ‘40:80=1:2’.

In operation 1150, the image-editing apparatus 100 synthesizes the scaled object region with the background image. That is, in operation 1150, the image-editing apparatus 100 replaces a pixel at a position defined within the background image with a pixel of the object region so that the scaled object region can be synthesized with the background image.

In operation 920, the image-editing apparatus 100 performs an image matting for the inserted contour. That is, in operation 920, the image-editing apparatus 100 can employ Bayesian/Poisson matting method and the like to perform the image matting which adjusts a pixel value of the boundary (or edge) portion of the image object, i.e. the person, inserted into the background image so that the boundary portion of the person can be smoothly synthesized.

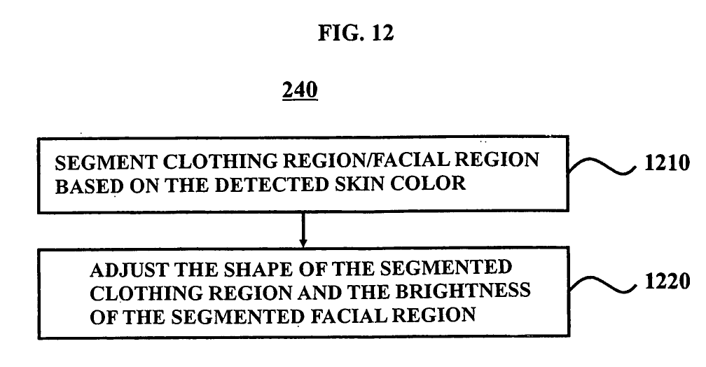

In operation 240, the image-editing apparatus 100 may edit the image for clothing/facial regions of the person using the optimized object contour. The process for the image-editing apparatus 100 to edit images for the clothing and facial regions of the person in operation 240 will be described hereinafter in more detail with reference to FIG. 12.

FIG. 12 is a flowchart illustrating a process for editing images for the clothing and facial regions of a person in the image-editing method according to an embodiment of the present invention.

Referring to FIG. 12, the image-editing apparatus 100 detects a skin color of the person from the optimized contour, and segments a clothing region and a facial region based on the detected skin color of the person.

In operation 1220, the image-editing apparatus 100 adjusts the shape of the segmented clothing region and the brightness of the segmented facial region.

As such, in the image-editing method according to an embodiment of the present invention, the object contour is optimized from the input image data, a skin color of the person in the input image data is detected based on the optimized contour to segment the clothing region and the facial region, and the shape of the segmented clothing region and the brightness of the segmented facial region are adjusted so that a user can edit the input image data in the form of various images.

In operation 240, the image-editing apparatus 100 may edit the image data to adjust the brightness of the background region for the image data using the optimized contour.

As such, in the image-editing method according to an embodiment of the present invention, the object contour is optimized from the input image data, the background region and the object region in the input image data are segmented based on the optimized contour, and the brightness of the segmented background region can be adjusted so that a user can adjust the background region.

Therefore, the present invention can provide a more discriminating image-editing service in a variety of devices (for example, personal video recorders, home servers, smart mobile devices, etc.) which allow a user to store and view photographs and videos using an automated contour-extracting algorithm. In addition, since the contour can be extracted precisely, the present invention can be applied to a photo-browsing service.

The image-editing apparatus according to the present invention may include a computer-readable medium including a program instruction for executing various operations realized by a computer. The computer-readable medium may include a program instruction, a data file, and a data structure, separately or cooperatively. The program instructions and the media may be those specially designed and constructed for the purposes of the present invention, or they may be of the kind well known and available to those skilled in the art of computer software arts. Examples of the computer-readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as that produced by a compiler, and files containing high-level language codes that may be executed by the computer using an interpreter.

According to the present invention, there is provided a method and apparatus for editing an image using an object contour to extract, from a complex background image, a body in a foreground.

Also, according to an embodiment of the present invention, there is provided an image-editing method and apparatus, in which a contour extracted from image data is optimized to be synthesized with any other background scene.

Further, according to an embodiment of the present invention, there is provided an image-editing method and apparatus, in which an object contour extracted from image data is optimized, a clothing region and a facial region of an image object, i.e. a person, is segmented using skin color detection, and the shape of the segmented clothing region and the brightness of the segmented facial region are adjusted.

Further still, according to an embodiment of the present invention, there is provided an image-editing method and apparatus, in which a personal contour extracted from image data is optimized, and then the brightness of the background region is adjusted.

In addition, the present invention can provide various image-editing services which a user desires through the automated extraction of the contour.

Furthermore, the present invention can provide a more discriminating image-editing service in a variety of devices which allow a user to store and view photographs and videos using an automated contour-extracting algorithm since it can be applied to a photo-browsing system.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of editing an image using a contour-extracting algorithm, the method comprising:
inputting image data;
extracting an object contour from the input image data;
optimizing the extracted contour using characteristics of the input image data;
editing the input image data using the optimized contour; and
outputting the edited image data.

2. The method of claim 1, wherein the extracting an object contour from the input image data further comprises:
extracting a position of an image object from the input image data;
extracting initial contour data from the input image data using a specific contour model;
extracting gradient information from the input image data; and
modifying the extracted initial contour data using the extracted gradient information;
wherein the image object may be an image of a person.

3. The method of claim 2, wherein the extracting a position of the image object further comprises detecting at least one of a face, eyes, and a skin color of the person from the input image data.

4. The method of claim 2, wherein the extracting initial contour data further comprises extracting a size of the person based on a distance between both eyes of the person, and subjecting the extracted person size to a model scaling to represent the object contour as control points.

5. The method of claim 2, wherein the extracting initial contour data further comprises representing the contour model by eigenvectors generated using training images.

6. The method of claim 2, wherein the extracting gradient information further comprises extracting gradient information from the input image data using a gradient vector flow (GVF).

7. The method of claim 2, wherein the modifying of the extracted initial contour data further comprises moving control points of the initial contour to a pixel having a high edge density.

8. The method of claim 7, wherein moving control points of the initial personal contour comprises moving the control points of the initial object contour using characteristics that alter a direction of a gradient information vector in a pixel having a high edge density.

9. The method of claim 1, wherein the optimizing the extracted contour further comprises:
retrieving the optimum contour by utilizing the input image data and a specific learned contour model; and
modifying the contour model by utilizing the retrieved optimum contour.

10. The method of claim 9, wherein the retrieving the optimum contour further comprises retrieving a control point of the optimum contour from current image data using the characteristics of the input image data and the specific learned contour model.

11. The method of claim 10, wherein the retrieving a control point of the optimum contour further comprises selecting a neighboring pixel in which a result value of an energy function for the input image data is a minimum and determining the selected neighboring pixel as a new control point.

12. The method of claim 11, wherein the energy function is an objective function which specifies a condition for deciding the control point corresponding to the objectcontour.

13. The method of claim 10, wherein the modifying the contour model further comprises adding a difference value between the retrieved control point and a control point of the contour model to the control point of the contour model.

14. The method of claim 1 further comprising:
receiving a request for correction of the contour from a user; and
adjusting a position of a control point for the extracted contour in response to the received request for correction of the contour,
wherein the optimizing the extracted object contour comprises optimizing the contour according to an energy function altered due to the adjusted position of the control point for the extracted contour.

15. The method of claim 1, wherein editing the input image data using the optimized contour comprises:
inserting the optimized contour into a predetermined background image; and
subjecting the inserted contour to an image matting.

16. The method of claim 15, wherein the inserting the optimized contour further comprises:
scaling the optimized contour to conform to a resolution of the predetermined background image; and
inserting the scaled contour into a desired position of the predetermined background image.

17. The method of claim 15, wherein the inserting the optimized contour further comprises:
receiving resolution information related to the predetermined background image, an object region and a person image;
calculating the scaling ratio between the person image and the background image based on the resolution information of the person image and the predetermined background image;
generating a bounding box using a largest width and height of the object region;
scaling the object region to conform to the calculated scaling ratio between the person image and the predetermined background image and a ratio of the bounding box; and
synthesizing the scaled object region with the predetermined background image.

18. The method of claim 15, wherein inserting the optimized contour further comprises designating a position where an edge density of the predetermined background image is lowest as a position for the object contour to be inserted, and inserting the optimized contour into the designated position.

19. The method of claim 1, wherein editing the input image data using the optimized contour further comprises:
detecting skin color of an image object from data about the optimized contour and segmenting a clothing region and a facial region of the object contour; and
adjusting a shape of the segmented clothing region and a brightness of the segmented facial region;
wherein the image object may be an image of a person.

20. The method of claim 1, wherein editing the input image data using the optimized contour further comprises adjusting a brightness of a background region of the input image data against the optimized contour.

21. A computer-readable recording medium storing therein a program to control an apparatus according to the method of claim 1.

22. An apparatus for editing an image using a personal contour-extracting algorithm, the apparatus comprising:
an image input section for inputting image data;
a contour-extracting section for extracting an object contour from the input image data applied to the contour-extracting section from the image input section;
a contour-optimizing section for optimizing the extracted contour applied to the contour-optimizing section from the contour-extracting section using characteristics of the input image data;
an image-editing section for editing the image data using the optimized extracted contour applied to the image-editing section from the contour-optimizing section; and
an image output section for outputting the edited image data applied to the image output section from the image-editing section.

23. The apparatus of claim 22, wherein the contour-extracting section detects at least one of a face, eyes, and a skin color of an image object from the input image data, and extracts initial contour data from the input image data using a specific contour model;
wherein the image object may be an image of a person.

24. The apparatus of claim 22, wherein the contour-optimizing section optimizes the extracted contour using characteristics of energy or an edge of the input image data.

25. The apparatus of claim 22, wherein the image-editing section synthesizes the optimized contour with a background image, edits at least one of a clothing shape or a face of the contour, or adjusts a brightness of a background region of the input image data.

26. A method of updating a contour model used to edit an image, comprising:
extracting an object contour from inputted image data;
optimizing the extracted contour using characteristics of the inputted image data and a specific learned contour model; and
updating the contour model to conform to the optimized object contour.

27. An apparatus for editing an image, comprising:
a contour-extracting section extracting an object contour from inputted image data;
a contour-optimizing section optimizing the extracted contour using characteristics of the inputted image data and a specific learned contour model; and
an image-editing section editing the image data using the optimized extracted contour.
